(19) United States
(12) Patent Application Publication
(10) Pub. No.: US 2013/0286642 A1
(43) Pub. Date: Oct. 31, 2013

(54) Systems and Methods for Generating a Flickering Flame Effect in an Electric Candle

(71) Applicant: CANDELLA, LLC, Orange, CA (US)

(72) Inventor: Douglas Patton, Irvine, CA (US)

(73) Assignee: Candella, LLC, Orange, CA (US)

(21) Appl. No.: 13/871,895

(22) Filed: Apr. 26, 2013

Related U.S. Application Data
(60) Provisional application No. 61/638,969, filed on Apr. 26, 2012.

(51) Int. Cl. F21L 13/00

(52) U.S. Cl. CPC F21L 13/00
USPC 362/192

(57) ABSTRACT

Systems and methods are described for generating chaotic movement in a movable flame element of an electric light. A signal generator can cause a drive mechanism of the electric light to provide kinetic motion to the flame element via a magnetic field, air pressure or otherwise.

This application claims the benefit of priority to U.S. provisional application having Ser. No. 61/638,969 filed on Apr. 26, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is systems and methods for simulating a flickering flame effect in an electric light.

### BACKGROUND

The following background discussion includes information that may be useful in understanding the present invention. It is not an admission that any of the information provided herein is prior art or relevant to the presently claimed invention, or that any publication specifically or implicitly referenced is prior art.

It is known to utilize a square wave pulse to produce a magnetic field capable of producing kinetic movement in a movable element of an electric candle. See, e.g., U.S. Pat. No. 7,837,355, U.S. Pat. No. 8,070,319, U.S. Pat. No. 8,132,936, U.S. Pat. No. 8,342,712, and WIPO publ. no. WO 2010/039347 to Schnuckle, et al. However, such references fail to contemplate that a more realistic effect can be effected by varying one or more the parameters of a pulse to be non-constant.

Thus, there is still a need for non-constant signals that are effective to generate a flickering flame effect of a flame element in an electric candle.

### SUMMARY OF THE INVENTION

The inventive subject matter provides apparatus, systems and methods in which one can generate a flickering flame effect in an electric candle or other lighting device through the use of a non-constant signal having a predefined waveform. Preferred waveforms have non-constant high-times and low-times, although signals having a constant high-time or low-time are also contemplated.

Preferred electric candles include a candle housing having a flame element at least partially extending from the housing. A drive mechanism can be configured to cause movement of the flame element, such as by using a magnetic field to interact with a magnet of the flame element, using air to cause movement of the flame element, or other manners of movement.

A signal generator can be coupled to the drive mechanism, and configured to cause the drive mechanism to provide the kinetic motion to the flame element, Preferably, the signal generator is configured to generate a signal having non-constant high-times (pulses with varying durations) and low-times (off periods between pulses). Although it is preferred that the signal generator is disposed within the candle housing, it is alternatively contemplated that the signal generator could be disposed outside of the housing, and coupled to a drive mechanism in the housing.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is one embodiment of an electric light.

FIG. 2 is an exemplary embodiment of a waveform having a variable low-time.

FIG. 3 is an exemplary embodiment of a waveform having a variable high-time.

FIGS. 4-5 are exemplary embodiments of waveforms having variable high-times and low-times.

FIGS. 6-7 are exemplary embodiments of a composite waveform.

### DETAILED DESCRIPTION

It should be noted that the following description may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including more accurately replicating the natural movements of a flame in an electric candle or other lighting device.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

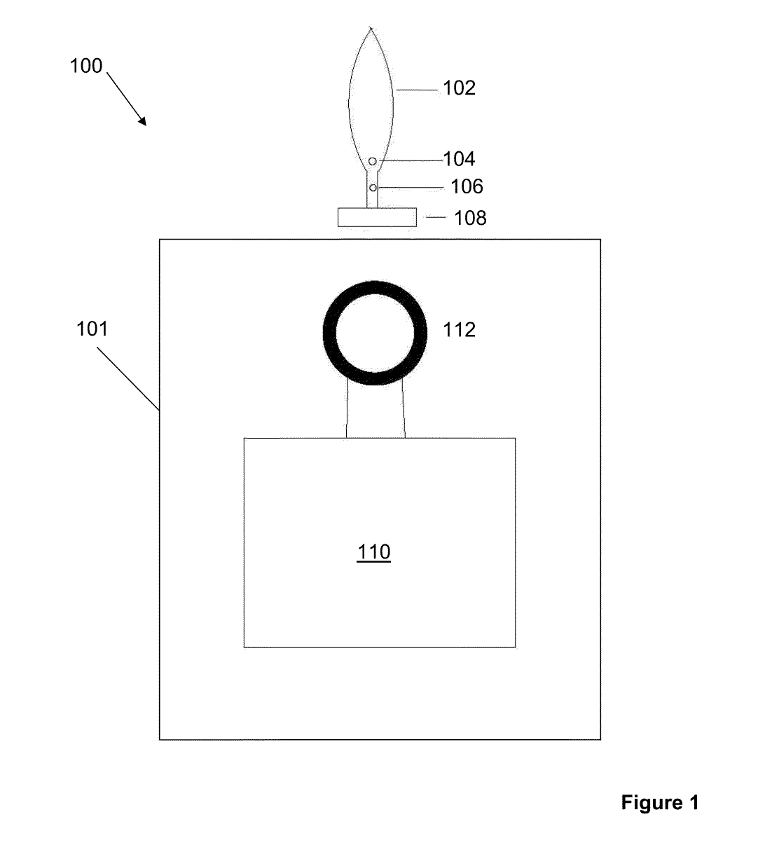

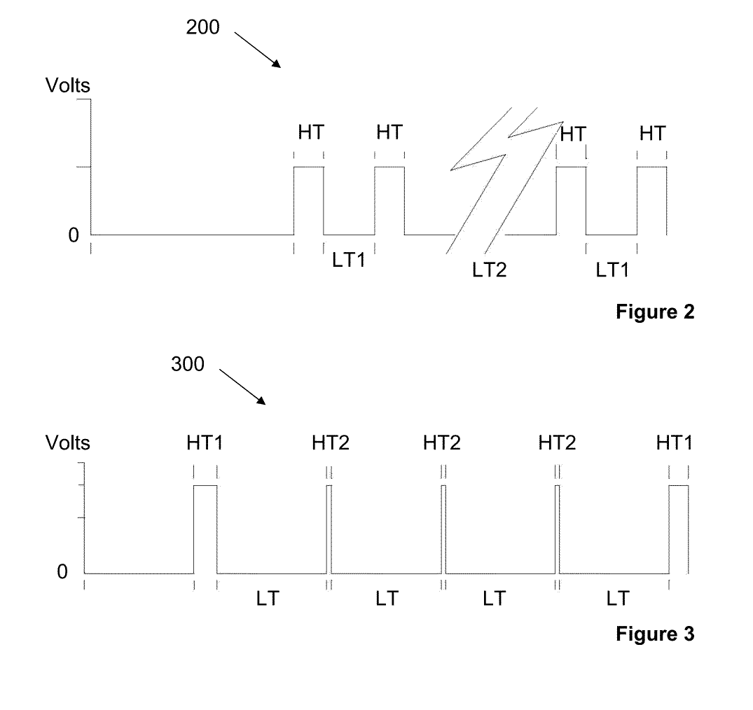

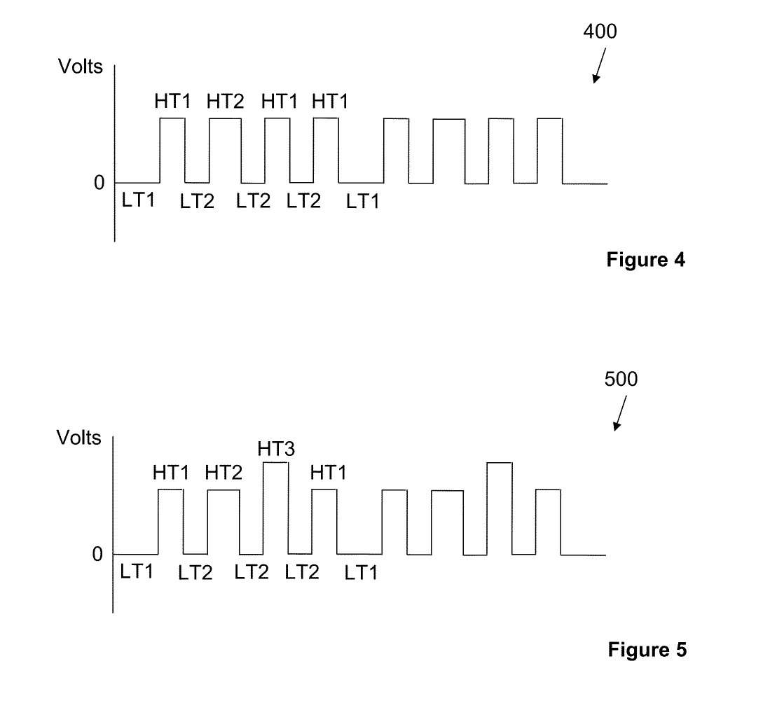

In FIG. 1, one embodiment of an electric candle 100 is shown having a housing 101 with a microcontroller 110 disposed in the housing 101 and configured to produce time-varying, spaced pulses. Although preferred pulses having varying durations (high-times) and low-time or off periods between the pulses such as that shown in FIGS. 4 and 5, it is contemplated that the pulses could have varying constant high-time or low-time periods such as that shown in FIG. 2 or 3, respectively.

In some contemplated embodiments, microcontroller 110 can be configured to produce square wave pulses that cause a magnetic field to be produced by coil of wire 112, although sine-wave and other non-square wave pulses are also contemplated including, for example, composite pulses.

Candle 100 can include a flame element 102 having a pivot point 104, about which the flame element 102 can move to produce a flickering flame effect. Preferably, the pivot point is disposed above a center of mass 106 of the flame element 102.

In embodiments where candle 100 comprises a drive mechanism capable of producing a magnetic field, such as a coil of wire 112 coupled to signal generator 110, it is contemplated that the flame element 102 can include one or more magnets 108, or alternatively, include a ferromagnetic material. The flickering effect is thereby produced by the movement of the flame element 102 occurs as a result of the interaction of the magnetic field(s) and forces between the magnet or other material coupled to the flame element 102 and the electromagnet, and the pendulum effect of the flame element 102.

The force of the magnetic field produced by the electromagnet 112 acting on the magnet 108 or other metal is determined by the voltage/current waveforms generated by the microcontroller 110. This force is defined by the following formula:

F=(N*I)²*μ₀*A)/(2*D²)

Where F is the force in Newtons, N is the number of turns in the electromagnet, I is the current in Amps, μ₀=1.2566375×10⁻⁶ for air, A is the area, and D is the length of the gap between the electromagnet and the metal or other material.

The magnetic field produced by the electromagnet 112 is governed by the following formula:

### ti B=(μ₀*N*A²*I)/2*(A²+Z²)^{3/2})

Where B is the magnetic field in Teslas, μ₀=1.2566375×10⁻⁶ for air, N is the number of turns in the electromagnet, A is the area, I is the current in Amps, and Z is the axial distance in meters from the center of the coil.

The current in the electromagnet 112 lags behind the voltage as a function of the impedance of the inductor. The greater the impedance, the less current, and vice versa. The resulting magnetic field also lags behind the voltage because the magnetic field is dependent upon the current. In addition, the pulses can create overlapping magnetic fields that interact, leading to less predictable and thereby more chaotic movement of the flame element 102. This results in a buildup of the magnetic force generated by the electromagnet 112 during the high-time of the pulse. Upon termination of the pulse's voltage, the magnetic field around the electromagnet begins to collapse but this decay is slowed by the circuit's inductance.

The force of the electromagnetic field on the flame element 102 results in chaotic movement of the flame element 102 because the pulses generate a variable magnetic field. This field causes the flame element 102 to move, which varies the distance and direction between the electromagnet and the magnet of the flame element 102. The magnetic field expands and collapses regularly but the timing of the pulses interacts differently because of the constantly changing repulsion and attraction forces.

The period of the flame element 102, when the flame element 102 is being affected by the pulses is indefinite because of the random additive and subtractive magnetic forces from the electromagnet 112. Because the pivot point 104 typically allows limited rotation as well as linear motion, the randomness of the interaction is further increased. Because the angle of the flame element 102 is small the period of the flame element 102 can be approximated by using formula below:

T=2π*√(I/m*g*R)

Where T is the period in seconds, I is the moment of inertia of the pendulum about the pivot point, m is the mass of pendulum, g is the gravitational force, and R is the distance between the flame element and the coil.

When there is a positive pulse from the circuits to the electromagnet 112, the value of g includes the forces from the magnetic field in addition to the force of gravity thereby greatly impacting the duration of the period and movement of the compound pendulum.

The unique flickering effect of the flame element 102 results from the apparent random motion of the flame element 102 and the collapsing and expanding of magnetic fields interacting with the dynamics of the flame element 102.

In other contemplated embodiments, the drive mechanism could comprise a fan. In such embodiments, it is preferred that the microcontroller 110 be configured to cause the fan to have a varying fan speed to simulate the flickering flame effect with the flame element 102. Thus, rather than simply run the fan continuously for extended time periods, the fan can be instead run at varying speeds, varying durations, and/or turned on and off for set time periods to generate the flickering flame effect. These variations in operation of the fan may be repeating or non-repeating within a specified time period.

In an exemplary embodiment, it is contemplated that the microcontroller 110 could cause power the fan for 500 ms to 2 seconds, more preferably between 0.5 s-1.5 s, and then cease powering the fan for a period of between 200 ms to 8 s, more preferably between 500 ms to 3 s, still more preferably between 500 ms-1.2 s. Of course, the specific pattern and run durations and frequencies of the fan can vary depending on the size of the candle, the material of the flame element, and the desired effect. In some embodiments, it is contemplated that while the electric candle 100 is turned on, the fan may never stop completely where the pulses have a short duration between them.

In another contemplated embodiment, the fan could run at 20% of normal speed for 3 seconds, and then increase to normal speed for a set time period, such as 1 second. This difference in speed could be repeated, such that the fan speed varies over time. Such pattern could alternate between reduced and normal speeds, and it is contemplated that the frequency of the reduced speed segments can be fixed or varied over time.

In still another embodiment, the fan could run at the following pattern: 100% power for 3 seconds and then off for 500 ms, followed by 100% power for 1 second and then off for 1 second, followed by 100% power for a period of between 500 ms-5 seconds and then off for 5 seconds. This pattern can then be repeated while the fan is on, or alternated with one or more alternate patterns of fan operation. Of course, the fan speed could also be varied within the pattern.

FIG. 2 illustrates one embodiment of a waveform 200 comprising a series of square-wave pulses, each of which has a constant high-time period (HT). The waveform 200 further includes a variable (i.e., non-constant) low-time or off period between the pulses. In the specific embodiment shown, the low-time period (LT1) can be constant for a set number of pulses, and then include a longer off time (LT2) between the first and second sets of pulses, and between subsequent sets. It is further contemplated that the low-time period could vary further, such as by having three different low-time periods between the pulses and/or sets of pulses.

In such embodiments, it is contemplated that the voltage of the pulse can be between 0.1-12.0 volts, and more preferably between 0.3-2 volts, still more preferably no more than 1.5 volts, and most preferably between 0.3-1 volts. However, the specific voltage can vary depending on the size and weight of the flame element to be moved, the distance between the drive mechanism and the flame element, and so forth.

Preferred high-time pulse periods are between 10 ms-5 s, and more preferably between 100 ms-500 ms, and most preferably between 200 ms-300 ms. Preferred low-time periods are between 200 ms-2 s, with the longer low-time period (LT2) being at least twice of the shorter low-time period (LT1).

In contrast to FIG. 2, FIG. 3 illustrates another embodiment of a waveform 300 comprising a series of square wave pulses having variable high-time periods. The waveform 300 further includes a constant low-time or off period (LT) between each pulse. Preferably, the high-time period varies between a first period (HT1) of between 100-400 ms, and a second high-time period (HT2) of less than 150 ms. Although larger ranges are contemplated, it is preferred that overall the duration of the high-time periods could vary between 10 ms-1.5 s.

FIG. 4 illustrates another embodiment of a waveform 400 having a set of pulses with variable high-time periods (HT1, HT2) and variable low-time periods (LT1, LT2) between the pulses. Although shown as having two different high-time and low-time periods in the set of pulses, it is contemplated that the set could have three or more different durations of one or both of the high-time and low-time periods.

FIG. 5 illustrates another embodiment of a waveform 500 having a set of pulses with variable high-time periods (HT1, HT2) and variable low-time periods (LT1, LT2) between the pulses. The waveform also includes variable amplitudes. As shown in FIG. 5, high-time period (HT3) has an amplitude that is greater than high-time periods (HT1, HT2).

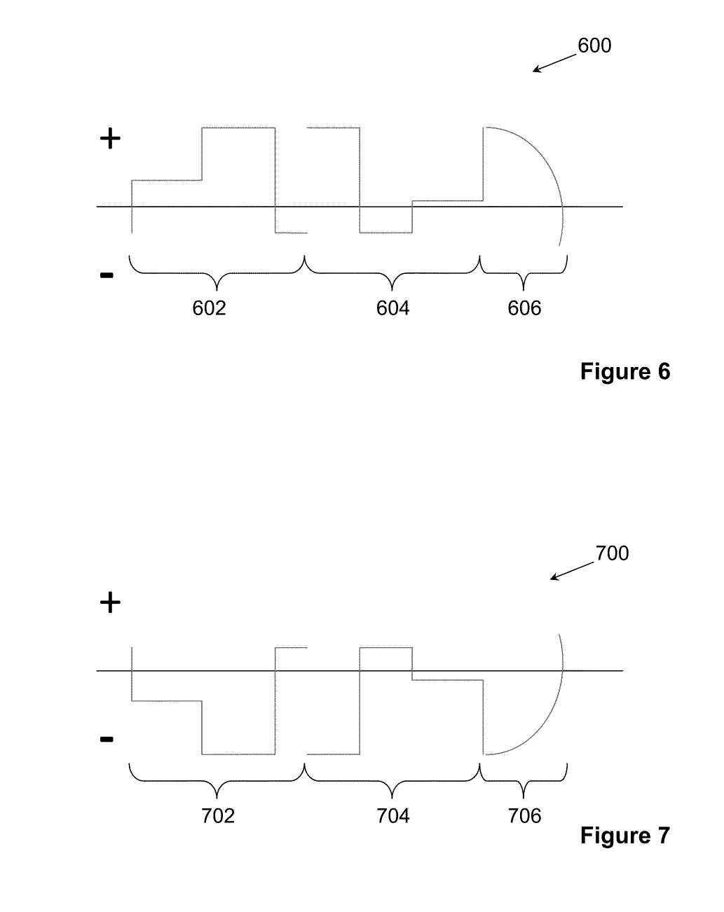

FIG. 6 illustrates an exemplary waveform 600 of an electronic signal is shown having first, second, and third sections 602, 604, 606. The non-periodic nature of the waveforms 600 provides a signal to an electronic device such as an electronic candle, for example, which can be used to simulate a seemingly random movement of an element of the device. This random movement contributes to the device's realistic appearance and thereby allows the device to more accurately simulate a candle or other product, especially when compared to electronic candles of the prior art that poorly imitate a real candle and thus have limited acceptance by consumers.

The electronic signal shown in waveform 600 comprises a non-periodic pattern that is a combination of two pulse sections 602, 604 and a curved section 606. Each of the sections 602, 604, 606 preferably oscillate at least once from positive to negative or negative to positive to generate at least a partial oscillation of an element of the electronic device. Thus, for example, for an electronic candle, such as that described in U.S. Pat. No. 8,070,319 to Schnuckle, et al., the variance from negative to positive or positive to negative causes an oscillation of the flame element of the electronic candle. By utilizing a composite waveform rather than a square wave or other periodic waveform, the oscillation of the flame element is non-uniform and thus more accurately simulates the movement of a real flame.

The segments could include one or more periodic waveforms including, for example, sine or square waves.

In especially preferred embodiments, the specific waveform is chosen to move or cause a change in polarity of an electronic and/or magnetic device and thereby cause physical movement of an element of the device that is exposed to a light source.

Although each of the segments is shown with a specific intensity, the actual intensity of each segment, and/or each portion of the segment, can be varied, provided that the collectively intensity is sufficient to noticeably move the element of the electronic candle or other device.

Although shown having three sections 602, 604, 606, it is contemplated that the waveform could have a single segment, or two or more segments, provided that the waveform collectively represents a non-periodic waveform. When the waveform has multiple segments, it is contemplated that the segments could have repeating or non-repeating changes in polarity.

It is also contemplated that the waveform could vary in duration, and could include pauses or breaks within a waveform. Still further, the device could include a series of waveforms, each of which has a duration that could be different from the duration of succeeding or preceding waveforms.

In still further contemplated embodiments, the device can produce multiple signals, which could each have a periodic or non-periodic waveform. The signals could be superimposed to form a resulting wave based on constructive interference (e.g., where different signals have the same polarities) or destructive interference (e.g., where different signals have different polarities) of the various signals.

The circuitry used to generate the pulses can also be simplified and it is possible that passive components (without a microcontroller) could be used to generate the pulses to drive the electromagnet.

FIG. 7 illustrates another embodiment of a waveform 700. With respect to the remaining numerals in FIG. 7, the same considerations for like components with like numerals of FIG. 6 apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for generating asynchronous movement in a movable flame element of an electric light, comprising:
a candle housing;
a drive mechanism disposed in the candle housing and configured to provide kinetic motion to a flame element; and
a signal generator disposed within the candle housing, and configured to cause the drive mechanism to provide the kinetic motion to the flame element, wherein the signal generator is configured to generate a signal having non-constant high-times and low-times.

2. The system of claim 1, wherein the signal comprises a series of square wave pulses having variable durations and varying off-time between at least some of the pulses.

3. The system of claim 1, wherein the signal comprises a periodic pattern.

4. The system of claim 1, wherein the signal comprises a non-periodic pattern.

5. The system of claim 4, wherein the non-periodic pattern comprises a composite waveform.

6. The system of claim 5, wherein the composite waveform comprises at least two of a pulse wave, a square wave, and a sine wave.

7. The system of claim 1, wherein the signal oscillates at least once in polarity.

8. The system of claim 1, wherein the drive mechanism comprises a coil of wire coupled to the signal generator.

9. The system of claim 1, wherein the drive mechanism comprises a fan.

10. The system of claim 1, wherein a duration of each of the high-time and low-time periods of the signal is no greater than 1.5 seconds.

11. The system of claim 10, wherein the duration of the high-time period is between 100-500 ms.

12. The system of claim 1, wherein the signal comprises a first pattern of pulses.

13. The system of claim 12, wherein the pulses are generated passively.
